(19) United States
(12) Patent Application Publication
(10) Pub. No.: US 2024/0302230 A1
(43) Pub. Date: Sep. 12, 2024

(54) FIBER BRAGG GRATING SENSOR WITH RESONANT CAVITY LED

(71) Applicant: CTS Corporation, Lisle, IL (US)

(72) Inventors: Devin Sullivan, Milton, MA (US); Xiaoxiao Lu, Granger, IN (US); Carlos Mateo Gutierrez, Albuquerque, NM (US); Anthony James Hoffman, Granger, IN (US); Milan Palei, Chicago, IL (US)

(21) Appl. No.: 18/588,592

(22) Filed: Feb. 27, 2024

Related U.S. Application Data
(60) Provisional application No. 63/488,911, filed on Mar. 7, 2023.

(51) Int. Cl. G01L 1/24

(52) U.S. Cl. CPC G01L 1/246

(57) ABSTRACT

A fiber Bragg grating sensor arrangement includes a resonant cavity light emitting diode for outputting light; a fiber having a first end disposed to receive light output from the resonant cavity light emitting diode, the fiber including fiber Bragg grating etched at one or more locations along a length thereof. A strain mount or beam supports the fiber and to which the fiber is attached or bonded. A light detection circuit disposed at a second end of the fiber receives light traveling through the fiber, the light detection circuit sensing intensity of the received light that corresponds to strain or force applied to the fiber that is bonded to the strain mount. Another fiber Bragg grating sensor arrangement includes a second reference fiber that does not receive a force or strain. The reference fiber provides an output used to prevent temperature/humidity from affecting the output of the FBG sensor arrangement.

### RELATED APPLICATIONS

This application claims priority to U.S. provisional application No. 63/488,911 filed Mar. 7, 2023 and titled “Fiber Bragg Grating Sensor With Resonant Cavity LED,” which is hereby incorporated by reference in its entirety.

### FIELD

This arrangement relates to a fiber Bragg grating sensor using a resonant-cavity light emitting diode and an intensity sensor.

### BACKGROUND

Optical fiber is most commonly used to transmit digital communications. By virtue of the physical properties of the quartz, glass, silica, or polymer that entails common fiber, whereby the fiber responds regularly and consistently to applied stress and environmental temperature changes, a fiber optic system, prepared in particular ways, may serve as reliable and sometimes advantageous force sensors and temperature sensors. Well known in the prior art, transitions of particular and precise spacing may be etched into optical fiber such that when subjected to an incident force (or temperature change), the spacing of the etchings changes in highly predictable and regular ways. Light sources, whose light is sufficiently consistent in power and spectrum can be directed and tuned to enter one end of the fiber. The light wave incident upon the etched region of the fiber (called a “grating”) encounters a boundary condition upon which some light is reflected and through which some light is transmitted. The spectral character of which and how much light is reflected versus transmitted changes as a repeatable and predictable function of the applied force or stress and environmental temperature.

Fiber Bragg grating-type transducers (for measuring stress/strain, temperature and other physical parameters) have come into common usage as sensors of stress and temperature where other means fall short. As a specialty sensor, their market price is a direct function of their relative rarity (low production volume), the specialized nature of the components that comprise the source and the interrogator, and the specialized nature of the equipment used to etch the grating into the fiber. In recent years, laser etching systems, entailing high power lasers with high throughput and fiber conveyance systems with high throughput, have been devised and demonstrated to enable high volume production of lengths of etched fiber for use as strain sensors and temperature sensors.

Fiber Bragg grating (FBG) sensors have been developed to monitor temperature, strain, humidity, and many other parameters-often simultaneously. Most implementations of FBG sensors are designed for high-sensitivity applications where it is necessary to measure small shifts in the wavelength of the light. To detect these small spectral changes, many implementations use optical spectrum analyzers, spectrometers, or spectral filters, which increase the overall cost of the sensor.

### SUMMARY

In one example, a fiber Bragg grating sensor arrangement comprises: a resonant cavity light emitting diode for outputting light; a fiber having a first end disposed to receive light output from the resonant-cavity light emitting diode, the fiber including fiber Bragg grating etching; a bonding agent coupling the fiber to a subject of measurement; and a light detection circuit disposed at a second end of the fiber for receiving light traveling through the fiber, the light detection circuit for sensing intensity of the received light that corresponds to strain or force applied to the subject of measurement.

In another example, the fiber Bragg grating sensor arrangement comprises: a resonant cavity light emitting diode for outputting light; a fiber having a first end disposed to receive light output from the resonant cavity light emitting diode, the fiber including fiber Bragg grating etching; a bonding agent coupling the fiber to a subject of measurement; and a light detection circuit disposed at a second end of the fiber for receiving light traveling through the fiber, the light detection circuit for sensing intensity of the received light that corresponds to strain or force applied to the subject of measurement. The arrangement further includes a reference fiber having a first end disposed to receive light output from the resonant cavity light emitting diode; and a reference light detection circuit disposed at a second end of the reference fiber for receiving light traveling through the reference fiber, the reference light detection circuit for sensing intensity of the received light that corresponds to no strain or force applied to the reference fiber.

Other advantages and features of the present arrangements will be more readily apparent from the following detailed description of the arrangements, the accompanying drawings, and the appended claims.

### BRIEF DESCRIPTION OF THE DRAWINGS

These and other features can best be understood by the description of the accompanying Figs. as follows:

FIG. 1 is a schematic view of a fiber Bragg grating sensor arrangement including a resonant-cavity light emitting diode;

FIG. 2 is a graph showing an example of light output by a resonant cavity light emitting diode that is received at various wavelengths by a light detector with no force applied to a fiber;

FIG. 3 is a graph showing an example of light output by a resonant cavity light emitting diode that is received at various wavelengths by the light detector with force applied to the fiber;

FIG. 4 is a graph of a filtered signal and a derivative of a filtered signal over a time period that includes changes in force applied to the fiber;

FIG. 5 is an enlarged graph showing the filtered signal B from FIG. 4; and.

FIG. 6 is a schematic view of a fiber Bragg grating sensor arrangement including a second fiber that can serve as a signal reference.

### DETAILED DESCRIPTION

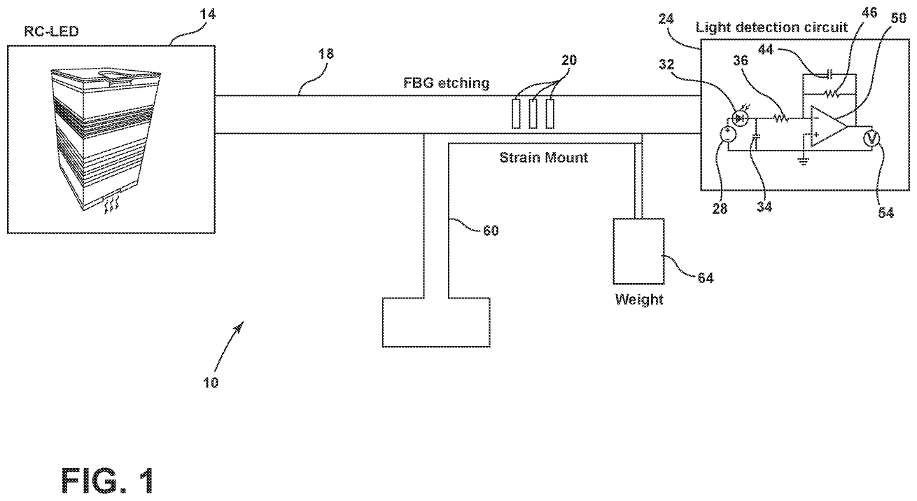

FIG. 1 depicts a fiber Bragg grating (FBG) sensor arrangement 10 that includes a resonant cavity light emitting diode (RC-LED) 14, a fiber 18 that has fiber Bragg grating (FBG) etching 20 spaced along a length of the fiber, and a light detection circuit 24. The fiber 18 is connected to receive light at a first end output from the RC-LED 14. The RC-LED 14 is coupled to the fiber 18 having the FBG etching 20. Typically, the RC-LED 14 is directly coupled to the fiber 18. In one example, the RC-LED is butt-coupled to the first end of the fiber 18. Light advances through the fiber 18 to the light detection circuit 24 at a second end thereof. The FBG etching 20 reflects light based on the tension/force applied to the fiber 18. In one example the fiber 18 is a single-mode fiber, for example a SMF-28 fiber, though fibers, including multimode fibers, may function with modified signal processing strategies.

The light detection circuit 24 shown in FIG. 1 includes a power source 28 and a photodetector, such as a photodiode 32 to sense intensity of the light received from the second end of the fiber 18. Other photodetectors that are contemplated include p-i-n photodiodes, p-n photodiodes, avalanche photodiodes, metal-semiconductor-metal photodetector, phototransistors, charge coupled devices, complementary metal-oxide-semiconductor sensors, and photomultiplier tubes. The light detection circuit 24 includes a first capacitor 34, a first resistor 36, a second capacitor 44, and a second resistor 46. The light detection circuit 24 includes an operational amplifier 50 and a voltage switch or measurement device 54. Other examples do not include the amplifier. Another example provides a current that is measured by a separate device.

FIG. 1 shows the fiber 18 secured by a bonding agent or material (not shown) to an extended portion of a strain mount 60. The bonding material can be an adhesive or other bonding device. In one example, the fiber 18 is mounted to a cantilever and the mass or weight 64 at the end of the cantilever is changed. FIG. 1 shows a weight 64 that provides a strain or force to the cantilevered strain mount 60 and thus the FBG etching 20. The strain mount 60 and weight 64 are for purposes of explanation only. In one embodiment, the fiber 18 is bonded to the subject to be measured such as strain mount 60 wherein the fiber and subject move monolithically when a force is applied to the subject causing strain to the subject, which strain is detected and measured in specific, repeatable, and accurate detail by the amount of light passing through the fiber 18 that is detected by the light detection circuit 24.

The FBG sensor arrangement 10 has many potential uses. The FBG sensor arrangement 10 is mounted or secured to measurement subjects along a length of the fiber 18 by the bonding agent or a bonding device (not shown). The fiber 18 is secured to building supports, such as pylons in one example. In another example, the fiber 18 of the FBG sensor arrangement 10 is mounted or adhesively secured to bridge supports of a bridge. In another example, the fiber 18 of the FBG sensor arrangement 10 is mounted onto a vehicle foot pedal as a foot pedal force sensor. In another example, the fiber 18 of the FBG sensor arrangement 10 is buried underground to detect footsteps about the perimeter of a secure facility. In another embodiment, the fiber 18 is immersed in cement that acts as a subject and as a bonding agent. Thus, the bonding agent is a cement bonding the fiber 18 to the subject formed by the cement. In many instances, use of a plurality of FBG sensor arrangements 10 is contemplated to measure tensile characteristics, such as force or strain. Other uses for the FBG sensor arrangement 10 are also contemplated to measure or provide a warning in response to sensed force, tensile, or strain exceeding a predetermined or predesigned value.

The RC-LED 14 is an important feature, as other surface light emitting diodes do not output light with enough intensity, in the first spatial mode, to allow measurement of strain. Further, the RC-LED 14 provides a low-cost solution for a FBG sensor arrangement 10. The coupling efficiency between the RC-LED 14 and the single-mode fiber 18 is greater than 200 times more efficient than a surface emitting light emitting diode that also may require additional components to dissipate heat. Additionally, the broadband light source provided by the RC-LED 14 mitigates the effects of manufacturing variations in the RC-LED 14 and the fiber 18 including the FBG etching 20. Thus, these features are crucial to the FBG sensor arrangement 10 performing properly.

In the FBG sensor arrangement 10 shown in FIG. 1, the light detection circuit 24 detects light at the second end of the fiber 18. Thus, the FBG sensor arrangement is free from an optical circulator to return light reflected by the FBG etching 20 toward the RC-LED for sensing thereat. By being free from an optical circulator, the FBG sensor arrangement 10 is less expensive than other FBG sensors.

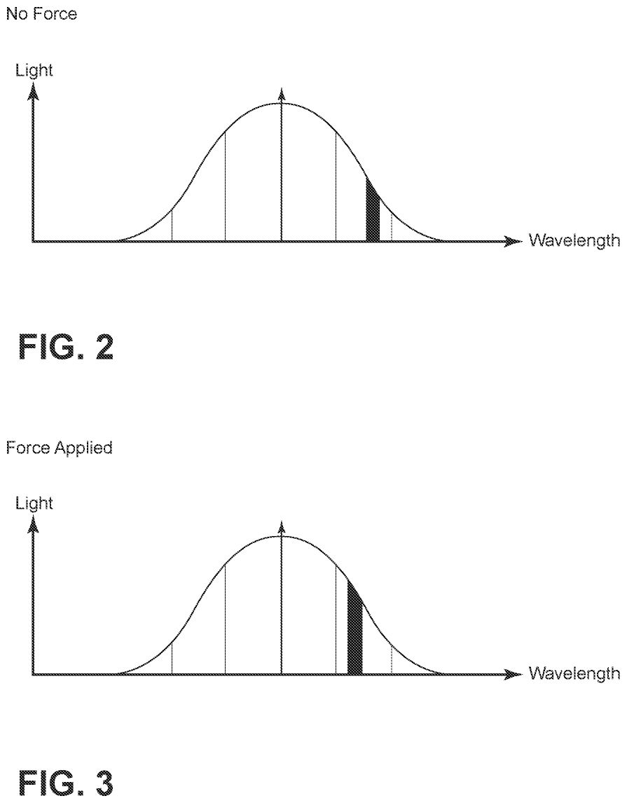

Changes in strain applied to the FBG etching 20 formed in the core of the fiber 18 causes Bragg wavelength shifts in the light reflected by the FBG etching. FIG. 2 shows an example of a graph of light intensity versus wavelength with no force applied to the fiber 18 and to the support or subject to be measured to which the fiber is attached. FIG. 3 shows the same example when compressive force, tensile, or strain is applied to the fiber 18 (via its attachment to the subject) of the FBG sensor arrangement 10. In this example, the wavelength of the reflected light decreases in value. Thus, a greater intensity of the light is reflected by the FBG etching 20 back toward the RC-LED 14 at the lower wavelength. Therefore, changes in the light intensity sensed by the light detection unit 24 occur due to the strain or force applied to the fiber 18. Due to the broadband nature of the light source, and photodetector, arranging full system embodiments where variation of strain within the desired range monotonically leads to direct variations in total intensity of light received, is straightforward and robust against many sources of common cause and special cause manufacturing error. The graphs shown in FIGS. 2 and 3 are explanatory in nature and not intended to represent a particular example of the disclosed arrangement.

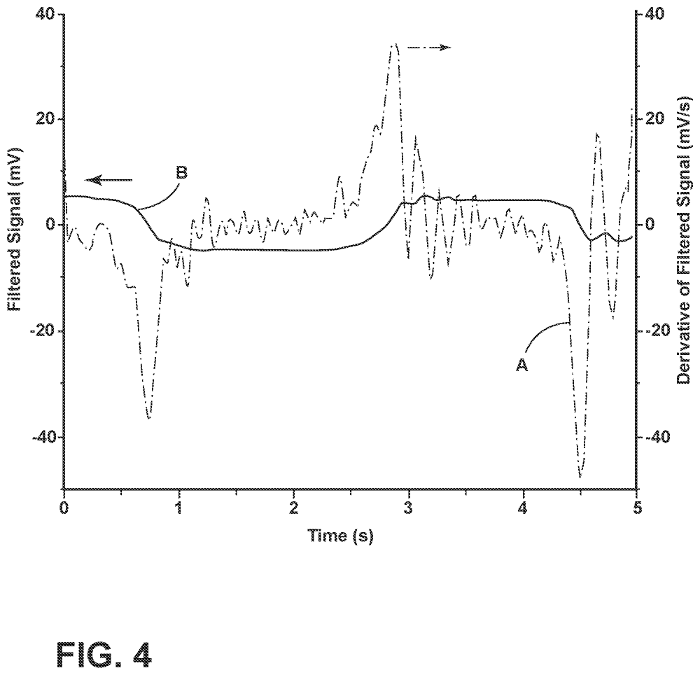

One operation of the FIG. 1 example is shown in the graph of FIG. 4. The horizontal line is time and the vertical line is millivolts and millivolts/second, depending at which line you are observing. At zero time a 5 pound weight 64 is applied to the arrangement shown in FIG. 1. In this arrangement, the RC-LED 14 at time zero is operating to output light intensity through the fiber 18 that is strained at the FBG etching 20 by a five pound weight. The RC-LED 14 is coupled to the single-mode fiber 18 without index matching epoxy. The light traverses the fiber 18, except for the light reflected by the FBG etching 20, to the light detection circuit 24, which senses the intensity of the light and provides an output to a measurement device 54. The light intensity received by the photodiode 32 depends on the center frequency of the FBG etching 20, which is linearly related to the strain across the fiber 18, and a spectral line-shape of the RC-LED. In one example, the voltage of line A corresponds to the output of the photodiode 32. The resistor 36 and capacitor 34 shown in the light detection circuit 24 act as a low-pass filter. Other low-pass filters are contemplated. The operational amplifier 50 amplifies the signal from the photodiode 32 and the resistor 46 and capacitor 44 smooth the feedback to the operational amplifier. Together, the operational amplifier 50, the capacitor 44, and the resistor 46 act as a transimpedance amplifier circuit used to amplify and convert the current from the photodiode 32 into a voltage. Other light detection circuits are contemplated.

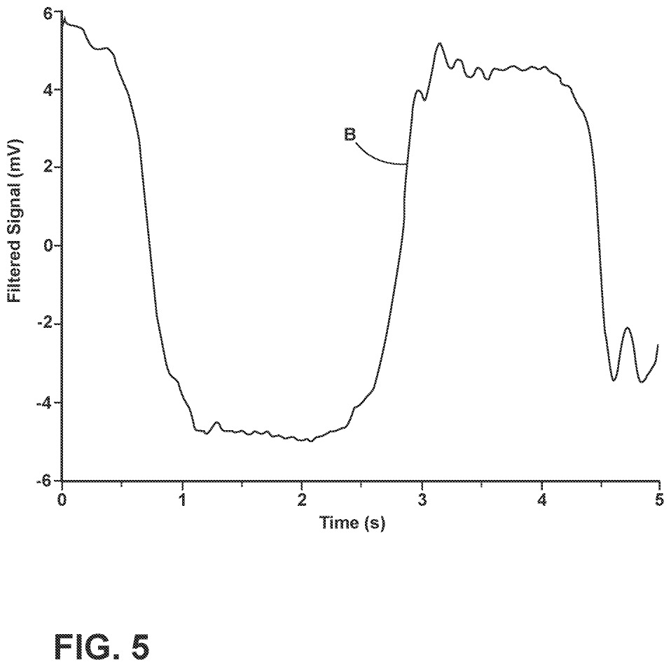

In another example, the output from the measurement device 54 is provided to a fifty Hertz digital or hardware filter (not shown) resulting in improvement of the filtered signal shown by line B of millivolts in FIG. 4. FIG. 5 is another representation of the line B corresponding integrated result of a filtered signal as shown in FIG. 4. The 50 Hertz digital filter provides 20 millisecond integration on filtered signals. The digital filter integrates for 20 milliseconds and then resets.

Returning to FIG. 4, more specifically at time 0 in the example of FIG. 4, no force is applied to strain the fiber 18. The output voltage is shown in FIG. 4. At about 1 second, the five pound weight is loaded in this example, and the voltage becomes negative quickly as shown by the derivative signal A. The voltage signal represented by line B also decreases.

FIG. 4 also shows the five pound weight being unloaded at approximately 3 seconds. The derivative of the filtered signal increases quickly as shown by voltage on line A of the graph. At the same time, the filtered signal shown by line B on the graph increases. Finally, at about 4.5 seconds, the five pound weight is reloaded and the derivative voltage signal shown by line A decreases quickly and the voltage signal represented by line B also decreases.

FIG. 5 shows that the voltage changes of the voltage signal represented by line B are capable of detection and can be measured to indicate a measurement of strain or utilized to control a switch of a warning system or other arrangement.

While five pounds was used for testing in this embodiment, sensing of other weights, including thousands of pounds are contemplated. the cumulative load or strain on supports or pylons of large structures for example, can be determined, as well as present load or strain on those supports or pylons. In some instances, the strain (in units of microstrain, or parts per million of tensile compression of expansion) is recorded.

While the light detection circuit 24 includes a photodiode 32 as shown in FIG. 1, other arrangements for sensing light intensity are contemplated. In one example a thermopile (not shown) detects light traveling through the fiber 18. Other optical light detectors are contemplated.

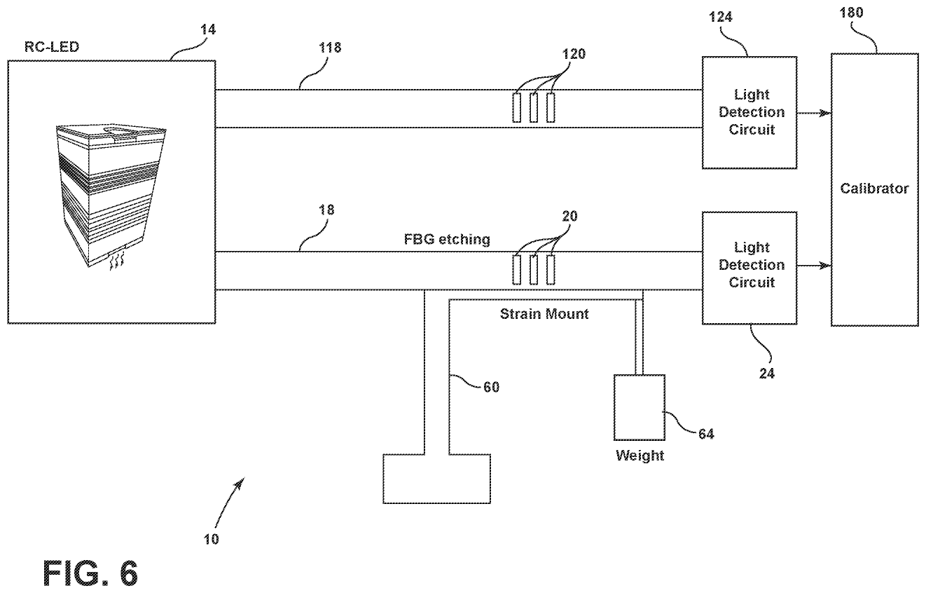

FIG. 6 illustrates another example that includes a first fiber 18, first FBG etching 20, and a first light detection circuit 24 that operate in the same manner as shown in FIG. 1 and discussed above. The RC-LED 14, however, provides light to the first fiber 18 and a second reference fiber 118. In one example, an optical coupler (not shown) receives light from the RC-LED 14 and outputs the light to the first fiber 18 and to the reference fiber 118. Thus, the fibers 18, 118 receive light from the single RC-LED 14. The fibers 18, 118 are spaced apart in FIG. 6 for purposes of illustration only. The reference fiber 118 does not include FBG etching in one arrangement. Another arrangement includes the same FBG etching 120 as the first fiber 18 as shown in FIG. 6. A reference light detection circuit 124 is provided that is an equivalent to the first light detection circuit 24 in one example. The reference fiber 118 does not have force or strain applied thereto under any conditions as it is not bonded or attached to the subject to be measured and thus, does not move monolithically with the subject being measured when a force is applied. FIG. 6 shows a reference unit 180 that receives the light intensity measured by the first light detection circuit 24 and the light intensity measured by the second reference light detection circuit 124.

Variations in temperature and/or humidity affect the wavelength of light reflected by the FBG etching 20. In operation, the first light detection circuit 24 provides a filtered signal of light intensity. The second reference light detection circuit 124 provides a filtered signal of light intensity with no force applied to the reference fiber 118.

The reference unit 180 receives the light intensity signals from both of the light detection circuits 24, 124. In one example, the difference between the light intensity signal from the first light detection circuit 24 with respect to the light intensity signal from the reference light detection circuit 124 corresponds to the force, tensile, or strain applied to the first fiber 18. Thus, the reference unit 180 determines the force or strain based on a comparison of the light intensity signal from the light detection circuit 24 and the light intensity signal of the reference light detection circuit 124.

In one arrangement the reference unit 180 is an analog reference unit that compares the light intensity signals. In another arrangement, the reference unit 180 is an application-specific integrated circuit (ASIC) representing an integrated circuit (IC) chip customized for comparing the light intensity signals. In another example, the reference unit 180 includes an electronic processor that receives information from an I/O interface and processes the information by executing instructions for one or more software algorithms stored in a memory, such as a read only memory (ROM). The electronic processor also stores information to and retrieves information from a random access memory (RAM via the input/output interface. The non-transitory computer readable memory modules may include volatile memory, non-volatile memory, or a combination thereof and, in various constructions, may also store operating system software, applications/instructions data for executing instructions, and combinations thereof. The reference unit 180 is capable of providing a warning signal to an indicator and/or controlling a device in response to a tensile, force, or strain greater than a predetermined or calculated value.

By avoiding variation in intensity due to temperature changes or humidity of the fiber 18, accuracy is further enhanced. The FIG. 6 arrangement is utilized to sense various strain and force applications as discussed above with respect to the FIG. 1 arrangement.

The FBG sensor arrangement 10 can also be operated in a reflection mode without an optical circulator. Here, the FBG etching 20 in the fiber 18 reflects a portion of the light. That portion of the light travels back down the fiber 18 in the direction of the source from where it came. The light interacts with a second structure with a designed modulation of the index of refraction that causes some or all of the reflected portion of light to be transmitted into free-space. An optical detector placed in a location that depends on the design of the structure with the designed index modulation detects the total intensity of the reflected light.

In one example, the resolution of the sensor is approximately 4.9 Newtons (N) (representing an underlying 100 microstrain) and the maximum applied force is 68.6 N (representing an underlying 1400 microstrain). Higher and lower forces, as well as high or lower strains, are quite feasible, limited by the sensitivity and range of the fundamental control parameter of the system, namely microstrain.

The graphs shown in FIGS. 2 and 3 are explanatory in nature and not intended to limit the scope of the claims.

The fiber Bragg grating sensor arrangement can account for shifts in the center frequency of the resonant cavity light emitting diode 14 due to temperature and humidity during manufacturing and can account for different lots and drift. The fiber Bragg grating sensor arrangement can also account from when the conditions of optical fiber etching are not carefully controlled and leading to drift, etc. The light detection circuit, such as a photodiode semiconductor in one example, is another possible source of error or drift. The fiber Bragg grating sensor arrangement is configured so that by virtue of its broadbandedness, the associated variance can be statistically aggregated and accounted for to obtain accurate results.

While the fiber Bragg grating sensor arrangement measures tensile characteristics, the tensile value can be used to determine strain, or indirectly to sense temperature for oil and gas field resource tracking. The fiber Bragg grating sensor arrangement can be used to measure strain and temperature to determine predictive failure in a smart manufacturing center. Further, the fiber Bragg grating sensor arrangement may be tagged to structural steel to monitor strain and anomalies in commercial construction projects, including wind turbines. The use of inexpensive resonant cavity light emitting diodes enable multiple sensor arrangements for detecting strain or temperature.

Numerous variations and modifications of the fiber Bragg grating sensor arrangements 10 as described above may be effected without departing from the spirit and scope of the novel features. It is to be understood that no limitations with respect to the arrangements illustrated herein are intended or should be inferred. It is, of course, intended to cover by the appended claims all such modifications as fall within the scope of the claims.

What is claimed is:

1. A fiber Bragg grating sensor arrangement comprising:
a resonant cavity light emitting diode for outputting light;
a fiber having a first end disposed to receive light output from the resonant-cavity light emitting diode, the fiber including fiber Bragg grating etching;
a bonding agent coupling the fiber to a subject of measurement; and
a light detection circuit disposed at a second end of the fiber for receiving light traveling through the fiber, the light detection circuit for sensing intensity of the received light that corresponds to strain or force applied to the subject of measurement.

2. The fiber Bragg grating sensor arrangement of claim 1, wherein the light detection circuit includes a power source, a photodetector, and an operational amplifier.

3. The fiber Bragg grating sensor arrangement of claim 1, wherein the fiber Bragg grating sensor arrangement is free from an optical circulator.

4. The fiber Bragg grating sensor arrangement of claim 1, wherein the fiber is a single-mode fiber.

5. The fiber Bragg grating sensor arrangement of claim 1, wherein the fiber is a multimode fiber.

6. The fiber Bragg grating sensor arrangement of claim 1, wherein the fiber is mounted to a pylon for sensing strain thereon.

7. The fiber Bragg grating sensor arrangement of claim 1, wherein the fiber is mounted to a bridge support for sensing strain thereon.

8. The fiber Bragg grating sensor arrangement of claim 1, wherein the bonding agent is an adhesive securing a length of the fiber to the subject.

9. The fiber Bragg grating sensor arrangement of claim 1, wherein the bonding agent is a cement bonding the fiber to the subject formed by the cement.

10. A fiber Bragg grating sensor arrangement comprising:
a resonant cavity light emitting diode for outputting light;
a fiber having a first end disposed to receive light output from the resonant cavity light emitting diode, the fiber including fiber Bragg grating etching;
a bonding agent coupling the fiber to a subject of measurement;
a light detection circuit disposed at a second end of the fiber for receiving light traveling through the fiber, the light detection circuit for sensing intensity of the received light that corresponds to strain or force applied to the subject of measurement;
a reference fiber having a first end disposed to receive light output from the resonant cavity light emitting diode; and
a reference light detection circuit disposed at a second end of the reference fiber for receiving light traveling through the reference fiber, the reference light detection circuit for sensing intensity of the received light that corresponds to no strain or force applied to the reference fiber.

11. The fiber Bragg grating sensor arrangement of claim 10, further comprising:
a reference unit for receiving a light intensity signal from the light detection circuit and a light intensity signal from the reference light detection circuit, the reference unit determining the tensile, force or strain based on a comparison of the light intensity signal from the light detection circuit and the light intensity signal of the reference light detection circuit.

12. The fiber Bragg grating sensor arrangement of claim 11, wherein the light detection circuit includes a power source, a photodetector, and an amplifier.

13. The fiber Bragg grating sensor arrangement of claim 11, wherein the fiber Bragg grating sensor arrangement is free from an optical circulator.

14. The fiber Bragg grating sensor arrangement of claim 11, wherein the fiber is a single-mode fiber.

15. The fiber Bragg grating sensor arrangement of claim 14, wherein the reference fiber is a single-mode fiber, and the reference fiber includes fiber Bragg grating etching.

16. The fiber grating sensor arrangement of claim 12, wherein the reference fiber is a single-mode fiber, and the reference fiber is free from fiber Bragg grating etching.

17. The fiber Bragg grating sensor arrangement of claim 10, wherein the bonding agent is an adhesive securing a length of the fiber to the subject.

18. The fiber Bragg grating sensor arrangement of claim 10, wherein the bonding agent is a cement bonding the fiber to the subject formed by the cement.

19. The fiber Bragg grating sensor arrangement of claim 11, wherein the fiber is a multimode fiber.
